(19) United States
(12) Patent Application Publication
(10) Pub. No.: US 2025/0048362 A1
(43) Pub. Date: Feb. 6, 2025

(54) SPATIAL MULTIPLEXING OF CONTROL INFORMATION FOR MASSIVE MULTIPLE-INPUT MULTIPLE-OUTPUT COMMUNICATIONS

(71) Applicant: QUALCOMM INCORPORATED, San Diego, CA (US)

(72) Inventors: Lior UZIEL, Hod Hasharon (IL); Shay LANDIS, Hod Hasharon (IL); Guy WOLF, Rosh Haayin (IL)

(21) Appl. No.: 18/837,161

(22) PCT Filed: Mar. 30, 2023
(86) PCT No.: PCT/US2023/016947

§ 371 Date: Aug. 8, 2024

(30) Foreign Application Priority Data
Apr. 15, 2022 (IL) 292299

(51) Int. Cl. H04W 72/1273; H04L 5/02

(52) U.S. Cl. CPC H04W 72/1273; H04L 5/026

(57) ABSTRACT

Methods, systems, and devices for wireless communications are described. In a wireless communications system, a network entity may determine to transmit first downlink control information (DCI) associated with a demodulation reference signal (DMRS) allocated to multiple resource elements of a control channel. The network entity may select a CDM group used for encoding second (e.g., future) DCI, for example, based on identifying a phase change pattern associated with the CDM group. A user equipment (UE) may monitor for the DMRS during a first time interval, and determine the CDM group for encoding the second DCI, for example using blind decoding. In some cases, the UE may receive the second DCI via the control channel based on the CDM group determined in association with the second DCI.

### CROSS REFERENCE

The present application is a 371 national stage filing of International PCT Application No. PCT/US2023/016947 by UZIEL et al. entitled “SPATIAL MULTIPLEXING OF CONTROL INFORMATION FOR MASSIVE MULTIPLE-INPUT MULTIPLE-OUTPUT COMMUNICATIONS,” filed Mar. 30, 2023; and claims priority to International Patent Application No. 292299 by UZIEL et al. entitled “SPATIAL MULTIPLEXING OF CONTROL INFORMATION FOR MASSIVE MULTIPLE-INPUT MULTIPLE-OUTPUT COMMUNICATIONS,” filed Apr. 15, 2022, each of which is assigned to the assignee hereof, and each of which is expressly incorporated by reference in its entirety herein.

### FIELD OF TECHNOLOGY

The following relates to wireless communications, including spatial multiplexing of control information for massive multiple-input multiple-output (MIMO) communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some cases, a network entity may transmit control information to one or more UEs in a massive multiple-input multiple-output (MIMO) system. In some examples, resource efficiency for the control information transmissions may be improved.

### SUMMARY

The described techniques relate to improved methods, systems, devices, and apparatuses that support spatial multiplexing of control information for massive multiple-input multiple-output (MIMO) communications. For example, the described techniques provide for control information to be spatially multiplexed using code division multiplexing (CDM) of one or more demodulation reference signals (DMRSs) associated with a physical downlink control channel (PDCCH). In some cases, a user equipment (UE) may monitor for downlink control information (DCI) associated with a DMRS allocated to multiple resource elements of a PDCCH. A network entity may select a particular CDM group for encoding future DCI (e.g., to be transmitted via the PDCCH). For example, the network entity may identify a quantity of DCI messages to transmit to the UE, determine a quantity of aggregation levels the network entity may use to transmit the DCI messages, and assign a CDM group to the UE based on the quantity of DCI messages and aggregation levels. In addition, the network entity may encode the future DCI using a particular pattern of phase change applied to the multiple resource elements, where the phase change may correspond to a positive or negative multiplier applied to the CDM group. In some cases, the UE may determine the CDM group, for example, using blind decoding, or based on an indication from the network entity. The UE may receive the future DCI from the network entity via the control channel and based on the CDM group the UE determined in associated with the future DCI.

A method for wireless communication at a UE is described. The method may include monitoring, during a first time interval, for a demodulation reference signal allocated to a set of multiple resource elements of a control channel, determining a CDM group for encoding DCI based on the monitored demodulation reference signal, and receiving the DCI via the control channel based on the CDM group determined in association with the DCI.

An apparatus for wireless communication at a UE is described. The apparatus may include a processor, and a memory coupled with the processor, wherein the memory comprises instructions executable by the processor to cause the apparatus to monitor, during a first time interval, for a demodulation reference signal allocated to a set of multiple resource elements of a control channel, determine a CDM group for encoding DCI based on the monitored demodulation reference signal, and receive the DCI via the control channel based on the CDM group determined in association with the DCI.

Another apparatus for wireless communication at a UE is described. The apparatus may include means for monitoring, during a first time interval, for a demodulation reference signal allocated to a set of multiple resource elements of a control channel, means for determining a CDM group for encoding DCI based on the monitored demodulation reference signal, and means for receiving the DCI via the control channel based on the CDM group determined in association with the DCI.

A non-transitory computer-readable medium storing code for wireless communication at a UE is described. The code may include instructions executable by a processor to monitor, during a first time interval, for a demodulation reference signal allocated to a set of multiple resource elements of a control channel, determine a CDM group for encoding DCI based on the monitored demodulation reference signal, and receive the DCI via the control channel based on the CDM group determined in association with the DCI.

In some examples of the method, apparatuses, and non-transitory computer-readable medium described herein, determining the CDM group may include operations, features, means, or instructions for receiving signaling indicating the CDM group for encoding the DCI.

In some examples of the method, apparatuses, and non-transitory computer-readable medium described herein, the signaling may be one or more of medium access control (MAC) signaling, an additional DCI, or radio resource control (RRC) signaling.

In some examples of the method, apparatuses, and non-transitory computer-readable medium described herein, a processing delay between receipt of the signaling and the first time interval may be based on whether the signaling may be received via MAC signaling, the additional DCI, or RRC signaling.

In some examples of the method, apparatuses, and non-transitory computer-readable medium described herein, determining the CDM group may include operations, features, means, or instructions for receiving an indication of the CDM group in RRC parameters associated with a control resource set in which the DCI may be received.

In some examples of the method, apparatuses, and non-transitory computer-readable medium described herein, determining the CDM group may include operations, features, means, or instructions for identifying a pattern for the CDM across the set of multiple resource elements as part of a blind decoding process, the pattern corresponding to a phase change pattern across the set of multiple resource elements that may be associated with the CDM group and determining the CDM group based on identifying the pattern that may be associated with the CDM group.

Some examples of the method, apparatuses, and non-transitory computer-readable medium described herein may further include operations, features, means, or instructions for decoding the control channel based on the monitored demodulation reference signal, where determining the CDM group may be based on the decoding.

Some examples of the method, apparatuses, and non-transitory computer-readable medium described herein may further include operations, features, means, or instructions for receiving a downlink message via a shared channel, the downlink message scheduled by the DCI, where the DCI and the downlink message may be received on a same beam.

In some examples of the method, apparatuses, and non-transitory computer-readable medium described herein, monitoring for the demodulation reference signal may include operations, features, means, or instructions for monitoring, during one or more additional time intervals, for the demodulation reference signal, where the DCI received via the control channel may be distinguishable from others of a set of multiple DCI received during the first time interval or the one or more additional time intervals based on the CDM.

In some examples of the method, apparatuses, and non-transitory computer-readable medium described herein, receiving the DCI may include operations, features, means, or instructions for receiving the DCI via a unicast transmission.

In some examples of the method, apparatuses, and non-transitory computer-readable medium described herein, receiving the DCI may include operations, features, means, or instructions for determining that the DCI may be associated with a DCI format or a random network identifier, where at least one of the DCI format or the random network identifier may be of a type with which CDM may be used.

In some examples of the method, apparatuses, and non-transitory computer-readable medium described herein, receiving the DCI may include operations, features, means, or instructions for receiving the DCI only via a layer corresponding to the CDM group.

A method for wireless communication at a network entity is described. The method may include determining to transmit, during a first time interval, first DCI associated with a demodulation reference signal allocated to a set of multiple resource elements of a control channel, selecting a CDM group for encoding second DCI based on determining to transmit the first DCI, and transmitting the second DCI via the control channel based on the CDM group selected for encoding the second DCI.

An apparatus for wireless communication at a network entity is described. The apparatus may include a processor, and a memory coupled with the processor, wherein the memory comprises instructions executable by the processor to cause the apparatus to determine to transmit, during a first time interval, first DCI associated with a demodulation reference signal allocated to a set of multiple resource elements of a control channel, select a CDM group for encoding second DCI based on determining to transmit the first DCI, and transmit the second DCI via the control channel based on the CDM group selected for encoding the second DCI.

Another apparatus for wireless communication at a network entity is described. The apparatus may include means for determining to transmit, during a first time interval, first DCI associated with a demodulation reference signal allocated to a set of multiple resource elements of a control channel, means for selecting a CDM group for encoding second DCI based on determining to transmit the first DCI, and means for transmitting the second DCI via the control channel based on the CDM group selected for encoding the second DCI.

A non-transitory computer-readable medium storing code for wireless communication at a network entity is described. The code may include instructions executable by a processor to determine to transmit, during a first time interval, first DCI associated with a demodulation reference signal allocated to a set of multiple resource elements of a control channel, select a CDM group for encoding second DCI based on determining to transmit the first DCI, and transmit the second DCI via the control channel based on the CDM group selected for encoding the second DCI.

Some examples of the method, apparatuses, and non-transitory computer-readable medium described herein may further include operations, features, means, or instructions for transmitting signaling indicating the CDM group for encoding the second DCI.

In some examples of the method, apparatuses, and non-transitory computer-readable medium described herein, the signaling may be one or more of MAC signaling, an additional DCI, or RRC signaling.

In some examples of the method, apparatuses, and non-transitory computer-readable medium described herein, a processing delay between receipt of the signaling and the first time interval may be based on whether the signaling may be received via MAC signaling, the additional DCI, or RRC signaling.

In some examples of the method, apparatuses, and non-transitory computer-readable medium described herein, transmitting the second DCI may include operations, features, means, or instructions for transmitting the second DCI via a unicast transmission.

In some examples of the method, apparatuses, and non-transitory computer-readable medium described herein, transmitting the second DCI may include operations, features, means, or instructions for determining that the second DCI may be associated with a DCI format or a random network identifier, where at least one of the DCI format or the random network identifier may be of a type with which CDM may be used.

In some examples of the method, apparatuses, and non-transitory computer-readable medium described herein, transmitting the second DCI may include operations, features, means, or instructions for transmitting the second DCI only via a layer corresponding to the CDM group.

In some examples of the method, apparatuses, and non-transitory computer-readable medium described herein, selecting the CDM group may include operations, features, means, or instructions for transmitting an indication of the CDM group in RRC parameters associated with a control resource set in which the second DCI may be transmitted.

In some examples of the method, apparatuses, and non-transitory computer-readable medium described herein, selecting the CDM group may include operations, features, means, or instructions for identifying a pattern for the CDM across the set of multiple resource elements, the pattern corresponding to a phase change pattern across the set of multiple resource elements that may be associated with the CDM group and selecting the CDM group based on identifying the pattern that may be associated with the CDM group.

Some examples of the method, apparatuses, and non-transitory computer-readable medium described herein may further include operations, features, means, or instructions for transmitting a downlink message via a shared channel, the downlink message scheduled by the second DCI, where the second DCI and the downlink message may be transmitted on a same beam.

In some examples of the method, apparatuses, and non-transitory computer-readable medium described herein, determining to transmit the first DCI may include operations, features, means, or instructions for determining to transmit, during one or more additional time intervals, the first DCI, where the second DCI transmitted via the control channel may be distinguishable from others of a set of multiple second DCI transmitted during the first time interval or the one or more additional time intervals based on the CDM.

### BRIEF DESCRIPTION OF THE DRAWINGS

FIG. 1 illustrates an example of a wireless communications system that supports spatial multiplexing of control information for massive multiple-input multiple-output (MIMO) communications in accordance with one or more aspects of the present disclosure.

FIG. 2 illustrates an example of a wireless communications system that supports spatial multiplexing of control information for massive MIMO communications in accordance with one or more aspects of the present disclosure.

FIG. 3 illustrates an example of a code division multiplexing (CDM) scheme that supports spatial multiplexing of control information for massive MIMO communications in accordance with one or more aspects of the present disclosure.

FIG. 4 illustrates an example of a process flow that supports spatial multiplexing of control information for massive MIMO communications in accordance with one or more aspects of the present disclosure.

FIGS. 5 and 6 show block diagrams of devices that support spatial multiplexing of control information for massive MIMO communications in accordance with one or more aspects of the present disclosure.

FIG. 7 shows a block diagram of a communications manager that supports spatial multiplexing of control information for massive MIMO communications in accordance with one or more aspects of the present disclosure.

FIG. 8 shows a diagram of a system including a device that supports spatial multiplexing of control information for massive MIMO communications in accordance with one or more aspects of the present disclosure.

FIGS. 9 and 10 show block diagrams of devices that support spatial multiplexing of control information for massive MIMO communications in accordance with one or more aspects of the present disclosure.

FIG. 11 shows a block diagram of a communications manager that supports spatial multiplexing of control information for massive MIMO communications in accordance with one or more aspects of the present disclosure.

FIG. 12 shows a diagram of a system including a device that supports spatial multiplexing of control information for massive MIMO communications in accordance with one or more aspects of the present disclosure.

FIGS. 13 through 17 show flowcharts illustrating methods that support spatial multiplexing of control information for massive MIMO communications in accordance with one or more aspects of the present disclosure.

### DETAILED DESCRIPTION

In some examples, a physical downlink control channel (PDCCH) may be mapped to a number of control channel elements (CCEs) according to an aggregation level. In some cases, as the size of a downlink control information (DCI) payload carried on a PDCCH increases and channel conditions of the PDCCH worsen, a larger aggregation level may be used to successfully transmit the DCI. In a massive multiple-input multiple-output (MIMO) system, for example, in a frequency division duplex (FDD) scenario, a network entity may support up to 64 user equipments (UEs) scheduled for uplink transmissions in a slot, and 64 UEs scheduled for downlink transmissions in the slot. As such, the network entity may transmit 128 DCI transmissions to account for each UE. Depending on a subcarrier spacing (SCS) used for the transmissions, the number of resources for a given SCS may be deficient to enable the network entity to transmit each of the 128 DCI transmissions.

Techniques described herein provide for spatial multiplexing of control information in a massive MIMO system. For example, control information may be spatially multiplexed using code division multiplexing (CDM) of one or more DCIs associated with the PDCCH. In some cases, a UE may monitor for DCI associated with a DMRS allocated to multiple resource elements of a PDCCH. A network entity may select a particular CDM group for encoding a future DCI (e.g., for transmission via the PDCCH). For example, the network entity may identify a quantity of future DCIs to transmit to the UE, determine a quantity of aggregation levels the network entity may use to transmit the future DCIs, and assign a CDM group to the UE based on the quantity of DCIs and aggregation levels. In addition, the network entity may encode the future DCIs using a particular pattern of phase change applied to the multiple resource elements, where the phase change may correspond to a positive or negative multiplier applied to the CDM group. In some cases, the UE may determine the CDM group, for example, using blind decoding, or based on an indication from the network entity. The UE may receive the future DCI from the network entity via the control channel and based on the CDM group the UE determined in association with the future DCI.

Aspects of the disclosure are initially described in the context of wireless communications systems. Aspects of the disclosure are then described in the context of CDM schemes and process flows. Aspects of the disclosure are further illustrated by and described with reference to apparatus diagrams, system diagrams, and flowcharts that relate to spatial multiplexing of control information for massive MIMO communications.

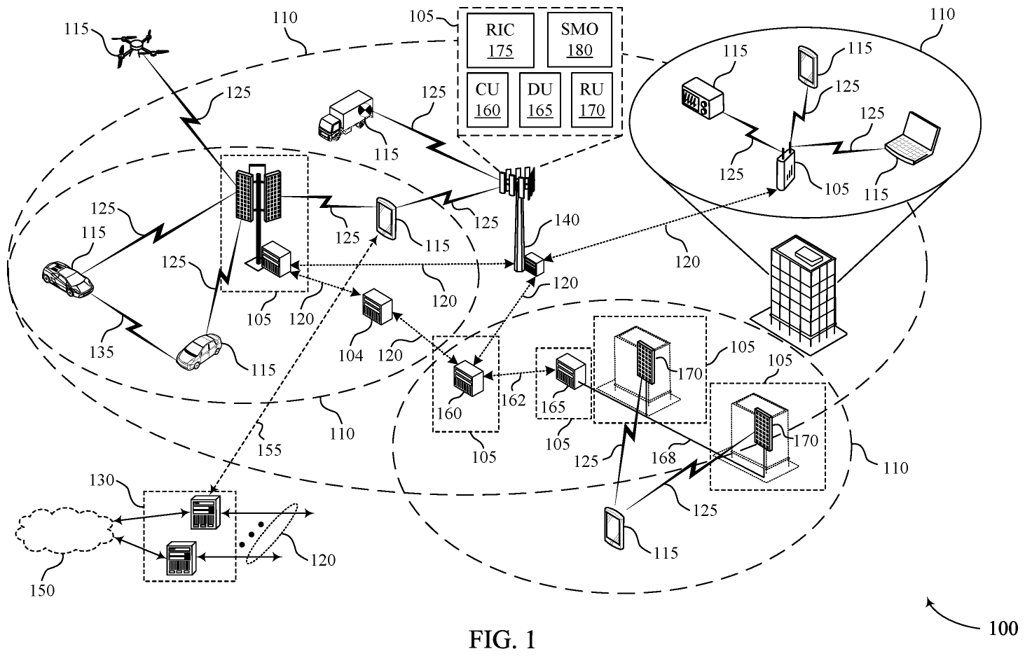

FIG. 1 illustrates an example of a wireless communications system 100 that supports spatial multiplexing of control information for massive MIMO communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support spatial multiplexing of control information for massive MIMO as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and SCS may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a SCS (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported SCS, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

In some wireless communications systems 100, a network entity 105 may communicate signaling with a UE 115 via a PDCCH, which may be mapped to a quantity of control channel elements (CCEs) (e.g., 1, 2, 4, 8, or 16 CCEs) according to an aggregation level to increase the chance of reception by the UE 115. That is, the aggregation level may increase the quantity of resources used to transmit the PDCCH. In some examples, each CCE may include six resource element groups (REGs) (e.g., or physical resource blocks (PRBs)), each REG spanning one resource block (RB) by one symbol, and each REG may include twelve resource elements per OFDM symbol. In some cases, the network entity 105 may compute how many resources on which to transmit a PDCCH based on a quantity of bits in the PDCCH. For example, considering that a PDCCH DMRS may occupy a quarter of the resource elements (e.g., subcarriers 1, 5, and 9), and that a PDCCH may be modulated using a 2-bit constellation quadrature phase shift keying (QPSK), each CCE may include 108 coded bits following that 6REGs*12REs*¼ non-DMRS*2QPSK, which may include information bits and bits used to code the PDCCH. In some examples, as a DCI payload (e.g., the payload of the PDCCH) increases and as channel conditions decrease, a network entity 105 may use a larger aggregation level to transmit the PDCCH. For example, in a non-massive MIMO communications system, the network entity 105 may use an aggregation level of 4 where the PDCCH may span four CCEs on average.

In some cases, a network entity 105 may use a PDSCH DMRS for channel estimation (e.g., rather than to transmit information). In some examples, transmitting more DMRSs may improve channel estimation by the network entity 105, however may limit the amount of information the network entity 105 may transmit. Because a PDSCH has numerous spatial layers, numerous antenna ports may be allocated for DMRSs. For example, the PDSCH may support up to eight spatial layers for type 1 DMRS transmissions and up to twelve spatial layers for type 2 DMRS transmissions. Each spatial layer may serve as a spatial stream allowing the network entity 105 to multiply the number of information or the number of resources used. For example, with 100 MHz of bandwidth or spectrum over 0.5 ms of that slot time, the resources may be 100 ms on frequency and on a particular time. However, if the network entity 105 performs spatial separation over multiple antenna ports (e.g., different spatial layers), then the network entity 105 may multiply the available resources.

A PDSCH DMRS may be designed to support single-user (SU) MIMO or MU-MIMO COMMUNICATIONS. In some examples, a network entity 105 may create CDM groups of PDSCH DMRSs that are separated spatially via code (e.g., CDM). The CDM groups may be protected from other CDM groups by different resource allocations in FDM. In addition, the CDM groups may be protected from PDSCH by having a PDSCH rate-match around all signaled CDM groups (e.g., instead of around just the PDSCH DMRS). In some cases, the PDSCH may support up to eight spatial layers with two CDM groups for a type 1 DMRS (e.g., antenna ports 1000 to 1007), and up to twelve spatial layers with three CDM groups for a type 2 DMRS (e.g., antenna ports 1000 to 1011), where a CDM group may support four DMRSs with a CDM-2 time domain and a CDM-2 frequency domain. A single UE 115 may be limited by eight layers (e.g., 2 CDM groups). In some cases, the network entity 105 may infer a PDSCH (e.g., data) channel estimation using the DMRSs. PDSCH resource elements may lack protection from interference from other layers, and as such, PDSCHs may be either precoded at the network entity 105 (e.g., the transmitter) or separated at the UE 115 (e.g., the receiver), which may occur before beam forming separation. As such, the network entity 105 may increase the amount of resources used for PDSCH transmissions.

In some examples, a PDCCH DMRS may be based on a per-CORESET configuration. Because a UE 115 may lack knowledge of when a PDCCH will be transmitted and may blind detect the PDCCH in a particular search space, the PDCCH may be a single layer with a single DMRS (e.g., antenna port p.=2000). As such, PDCCH DMRSs may lack spatial separation and span one fourth of the resource elements of the six REGs. For example, the PDCCH DMRSs may use the first, fifth, and ninth resources in an REG (e.g., semi-statically configured via CORESET-wideband-bundle set un-set), where a narrow band reference signal may be mapped on all REGs on all OFDM symbols of the PDCCH candidate, and where a wideband reference signal may be mapped on all REGs on all the OFDM symbols of the CORESET (e.g., using the same precoding).

In some cases, the quantity of CCEs used to transmit a PDCCH may be greater than the quantity of resources available. For example, for a 100 MHz for 30 kHz, the network entity 105 may use 273 PRBs in frequency (e.g., each PRB including 12 resource elements), the quantity of available CCEs may depend on the number of symbols in the CORESET (e.g., 1, 2, or 3) and the aggregation level (e.g., 1, 2, 4, 8 or 16). Taking the average aggregation level as 1 (e.g., 1 CCE), then the network entity 105 may have 45 locations to transmit the PDCCH with one symbol in the CORESET, 91 locations to transmit the PDCCH if there are two, and 137 locations to transmit the PDCCH if there are three symbols. If the aggregation level is 2 (e.g., 2 CCEs), the network entity 105 may have 22 locations to transmit the PDCCH if there is one symbol, 45 locations to transmit the PDCCH if there are two symbols, and 68 locations to transmit the PDCCH if there are three symbols, which may be half the space as for an aggregation level of 1.

For an aggregation level of 4, the network entity 105 may have 11 locations to transmit the PDCCH with one symbol, 22 locations to transmit the PDCCH with two symbols, and 34 locations to transmit the PDCCH with three symbols. If the aggregation level is 8, the network entity 105 may have 5 locations to transmit the PDCCH with one symbol, 11 locations to transmit the PDCCH with two symbols, and 17 locations to transmit the PDCCH with three symbols, and for an aggregation level of 16, the network entity 105 may have 2 locations to transmit the PDCCH with one symbol, 5 locations to transmit the PDCCH with two symbols, and 8 locations to transmit the PDCCH with three symbols. As such, taking the average aggregation level as 3, the network entity 105 may transmit 11 DCIs using one symbol, 22 DCIs using two symbols, and 34 DCIs using three symbols for control, which may sacrifice 21%, 14%, and 7% of the downlink resources of a full downlink slot, respectively.

In some examples, a network entity 105 in a massive MIMO scenario may support up to 16 aggregation layers. In addition, the network entity 105 may support 64 scheduled UEs 115 on the downlink and 64 scheduled UEs 115 on the uplink per slot for a 100 MHz channel bandwidth. In FDD communications, there may be a spectrum for uplink and a spectrum for downlink, and on the downlink, the network entity 105 may transmit DCIs that schedule both the downlink and the uplink. On that particular slot, in order to send control for 64 downlink and 64 downlink, the network entity 105 may transmit 128 DCIs (e.g., the network entity 105 may transmit data and control on the downlink). For FDD or TDD transmissions without an uplink-centric downlink-to-uplink ratio, the number of DCIs the network entity 105 may transmit may be the same as the number of scheduled UEs 115 on the downlink plus the number of UEs 115 scheduled on the uplink. For TDD transmissions with an uplink-centric downlink-to-uplink ratio, the number of DCIs the network entity 105 may transmit may be the same as the number of UEs 115 scheduled on the downlink plus a multiple number of UEs 115 scheduled on the downlink (e.g., per downlink-to-uplink ratio), neglecting broadcasts and other general control messages (e.g., DCIs with non-cell-radio network temporary identifiers (c-RNTIs)). That is, for the FDD case, the number of DCIs may be 128, which may only be satisfied on the aggregation level 1 using three symbols (e.g., 137 available resources), which may sacrifice 21% (e.g., 3 symbols) of the downlink resources. In the TDD case, with an uplink-centric downlink-to-uplink ratio, the resource deficiency may be higher (e.g., for an aggregation level 4, the network entity 105 may transmit approximately one fourth of the 128 DCIs).

Techniques described herein provide for spatial multiplexing of control information in a massive MIMO system. For example, control information may be spatially multiplexed using CDM of one or more DMRSs associated with the PDCCH. In some cases, a UE 115 may monitor for a DMRS allocated to multiple resource elements of a PDCCH. A network entity 105 may select a particular CDM group for encoding future DCI (e.g., for transmission via the PDCCH). For example, the network entity 105 may identify a quantity of future DCIs to transmit to the UE 115, determine a quantity of aggregation levels the network entity 105 may use to transmit the future DCIs, and assign a CDM group to the UE 115 based on the quantity of future DCIs and aggregation levels. In addition, the network entity 105 may encode the future DCI using a particular pattern of phase change applied to the multiple resource elements, where the phase change may correspond to a positive or negative multiplier applied to the CDM group. In some cases, the UE 115 may determine the CDM group, for example, using blind decoding, or based on an indication from the network entity 105. The UE 115 may receive the future DCI from the network entity 105 via the control channel and based on the CDM group the UE 115 determined in associated with the future DCI.

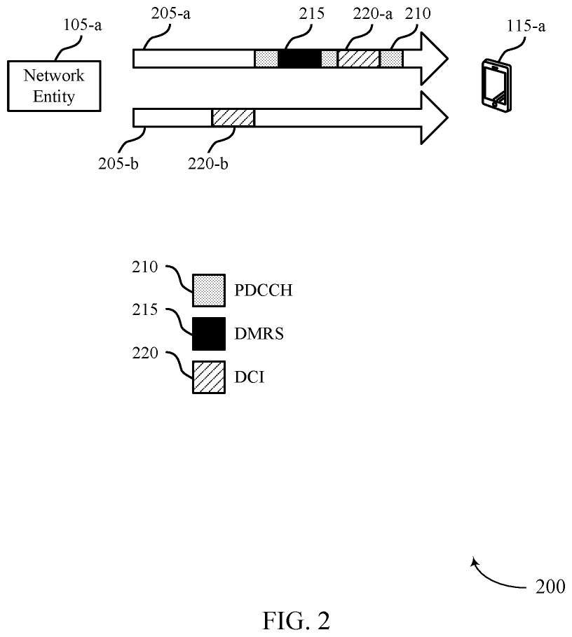

FIG. 2 illustrates an example of a wireless communications system 200 that supports spatial multiplexing of control information for massive MIMO communications in accordance with one or more aspects of the present disclosure. In some examples, the wireless communications system 200 may implement aspects of the wireless communications system 100 or may be implemented by aspects of the wireless communications system 100. For example, the wireless communications system 200 may include a network entity 105-a and a UE 115-a, which may be examples of corresponding devices described herein.

The network entity 105-a (e.g., a network entity) may communicate with the UE 115-a via a communications link 205-a and a communications link 205-b (e.g., a downlink). The network entity 105-a may transmit some communications via the communications link 205-a before transmitting subsequent (e.g., future) transmissions via the communications link 205-b. In some examples, the network entity 105-a may transmit signaling to the UE 115-a that may be allocated to multiple resource elements of a PDCCH 210 (e.g., a control channel), which may be a single layer transmission. That is, the network entity 105-a may unicast the PDCCH 210 to a particular UE 115 (e.g., the UE 115-a). In some cases, the PDCCH 210 may have a same transmit beam as a physical downlink shared channel (PDSCH) (e.g., indicated in a transmission configuration indication (TCI) state), particularly in a sub-THz system. As such, the same precoding for the PDSCH may apply to the PDCCH 210.

The wireless communications system 200 may support spatially multiplexing of PDCCHs using CDM to increase PDCCH 210 reception by the UE 115-a. During a first time interval, the UE 115-a may monitor the PDCCH 210 via the communications link 205-a for DCI 220-a (e.g., first DCI) associated with a DMRS 215 allocated to a set of resource elements of the PDCCH 210. In some examples, the network entity 105-a may select a CDM group for encoding DCI 220-b (e.g., second DCI, future DCI) based on determining to transmit the DCI 220-a, and encode the DCI 220-b accordingly. The CDM encoding may be based on a phase change pattern across the set of resource elements, where the phase change pattern may correspond to a positive or negative multiplier applied to the CDM group. In some examples, the UE 115-a may determine the CDM group used by the network entity 105-a for encoding the DCI 220-b. For example, as the UE 115-a may blind decode the PDCCH 210, the CDM group associated with the DCI 220-a and the DMRS 215 may be included in the blind decode process. That is, the network entity 105-a may lack the ability to notify the UE 115-a of the PDCCH 210 and the CDM group in a similar way as for a PDSCH (e.g., via DCI fields), and as such, the UE 115-a may use blind decoding to determine the CDM group.

In cases where the UE 115-a is limited by a quantity of blind decoding processes (e.g., by a UE capability), the UE 115-a may refrain from using blind decoding to determine the CDM group and limit the quantity of blind decoding processes used. In such cases, the network entity 105-a may determine how many future DCI transmissions to transmit to the UE 115-a and how many aggregation levels the network entity 105-a may use to transmit the future DCI transmissions. Based on the quantity of future DCI transmissions and the quantity of aggregation levels, the network entity 105-a may assign specific CDM groups to specific UEs 115. That is, the network entity 105-a may determine a CDM group based on a particular spatial processing that is to be used, where future DCI transmissions may use the determined CDM group. For example, the network entity 105-a may use a semi-static configuration to configure the CDM group for encoding the DCI 220-b.

The UE 115-a may receive, from the network entity 105-a, signaling indicating the CDM group for encoding the DCI 220-b, where the signaling may include MAC signaling, an additional DCI, or RRC signaling. In some cases, the semi-static configuration may be effective after a particular processing time in accordance with the signaling. That is, a processing delay between receipt of the signaling and the first time interval (e.g., the time period during which the UE 115-a may monitor for the DMRS 215) may be based on whether the signaling is received via MAC signaling, an additional DCI, or RRC signaling. In some examples, if the signaling includes MAC signaling or RRC signaling, the signaling may be transmitted before the network entity 105-a determines to transmit the DCI 220-a associated with the DMRS 215 in the PDCCH 210. In addition, the CDM group indicated to the UE 115-a in the MAC signaling or RRC signaling may be applied to a PDSCH scheduled by the PDCCH 210.

In some examples, the semi-static configuration may affect PDCCH unicast (e.g., failing to affect random access channel (RACH) procedures, radio resource management (RRM), broadcasted signals, or control signals). That is, the network entity 105-a may unicast an indication of each configured CDM group to individual UEs 115 (e.g., based on RNTIs that are particular for each UE 115). Once the network entity 105-a has indicated the semi-static configuration of the CDM group for encoding the DCI 220-b to the UE 115-a, the UE 115-a may know the CDM group and refrain from increasing the quantity of blind decoding processes it may use to identify other CDM groups. In addition, the network entity 105-a may reconfigure the CDM group for the UE 115-a and indicate the change of CDM group to the UE 115-a via additional signaling.

In some cases, the UE 115-a may receive the DCI 220-b from the network entity 105-a based on the CDM group determined in associated with the DCI 220-b (e.g., for encoding the DCI 220-b). That is, once the UE 115-a has determined the CDM group, the UE 115-a may receive the DCI 220-b, where the DCI 220-b may be different from the additional DCI used to receive the signaling in some cases. The UE 115-a may receive a downlink message scheduled by the DCI 220-b via a PDSCH on a same beam. For example, in a sub-THz system, the UE 115-a may communicate over the PDCCH 210 and a PDSCH which share the same beam (e.g., as indicated by a TCI state). In addition, the UE 115-a may receive the DCI 220-b via a unicast transmission and via a layer corresponding to the determined CDM group. For example, as the network entity 105-a may configure specific CDM groups for specific UEs 115, the network entity 105-a may unicast respective DCIs to each UE 115 using the specific CDM groups (e.g., the DCI 220-b to the UE 115-a).

In addition, the network entity 105-a may transmit the DCI 220-b to the UE 115-a via the layer for which the CDM group was determined (e.g., a negotiated layer). Additionally, the DCI 220-b may be associated with a particular DCI format (e.g., 0_0, 0_1, 0_2, 1_0, 1_1, 1_2) or a particular RNTI (e.g., a c-RNTI), where at least one of the particular DCI format or the particular RNTI is of a type with which CDM is for encoding the DCI 220-b. In this way, the DCI 220-b may be unicast to the UE 115-a, and other future DCIs may be unicast to other UEs 115. In some cases, the UE 115-a may monitor for the DMRS 215 during one or more additional time intervals (e.g., subsequent to the first time interval), where the DCI 220-b received may be distinguishable from others of a set of DCIs 220-b (e.g., second DCIs) received during the first time interval or the one or more additional time intervals based on the CDM. That is, the UE 115-a may receive additional DCIs 220 (e.g., different from the DCI 220-b) that are encoded with the same CDM and CDM group as the DCI 220-b.

In some examples, the network entity 105-a may identify that different UEs 115 support different CDM groups. In some examples, the UE 115-a may receive an indication from the network entity 105-a of the CDM group for encoding the DCI 220-b in RRC parameters associated with a CORESET in which the DCI 220-b is received. For example, the RRC parameters associated with the CORESET the UE 115-a may use to receive the DCI 220-b may list any CDM groups and CDM coding that is supported by that CORESET. In some examples, the network entity 105-a may semi-statically select a CDM group from the list for each UE 115. Selecting the CDM group in this way may fail to affect precoder granularity (e.g., per REG bundle and all contiguous) as split layers of the CORESET, and in partial overlapping CORESETs, the PDSCH may rate match around the scheduling DCIs. In some cases, the UE 115-a may be aware of the CDM group being used based on the CORESET (e.g., the UE 115-a may be aware of a location in which to blind detect the PDCCH 210).

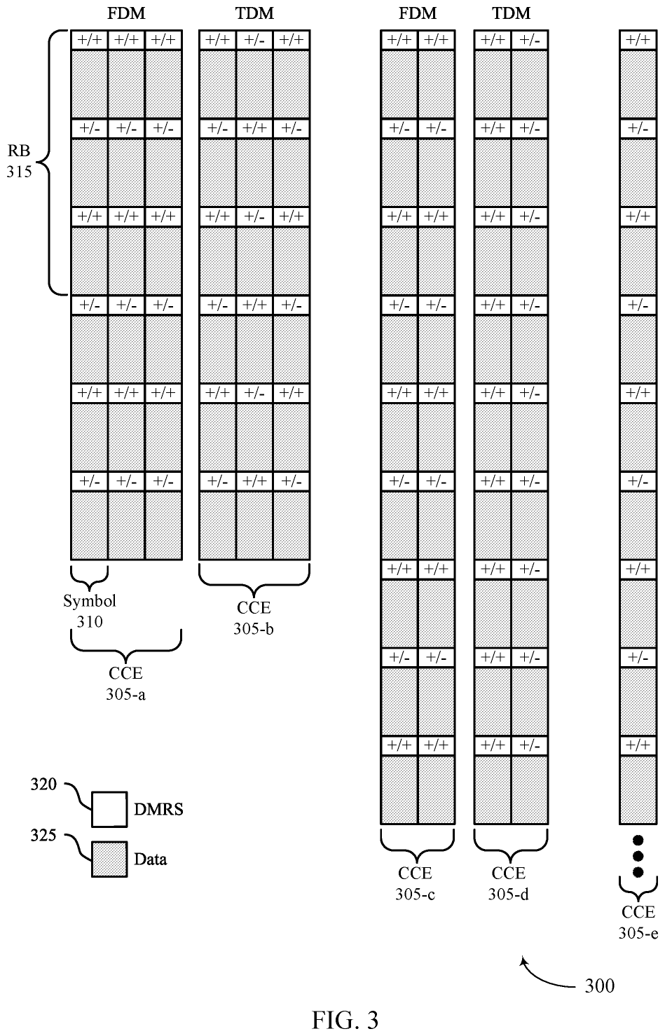

FIG. 3 illustrates an example of a CDM scheme 300 that supports spatial multiplexing of control information for massive MIMO communications in accordance with one or more aspects of the present disclosure. In some examples, the CDM scheme 300 may implement aspects of the wireless communications systems 100 and 200 or may be implemented by aspects of the wireless communications systems 100 and 200. In some examples, a network entity may apply the CDM scheme 300 to DMRSs 320 allocated to a set of RBs of a PDCCH. For example, the network entity may apply CDM to CCEs 305, which may include a quantity of DMRSs 320 and data 325 (e.g., DCI).

As described with reference to FIG. 2, a wireless communications system may support spatially multiplexing of PDCCHs using CDM to increase PDCCH reception by a UE. A PDCCH may be mapped to a quantity of CCEs 305 (e.g., 1, 2, 4, 8, or 16 CCEs 305) according to an aggregation level, where each CCE 305 may include six REGs. In some cases, the UE may monitor a PDCCH for a DMRS 320 allocated to a set of resource elements of the PDCCH and encoded using CDM. To enhance the mapping of a DMRS 320 to physical resources in an REG of a CCE 305, the network entity may introduce a CDM on top of each DMRS 320 allocation in a CCE 305. For example, after determining to transmit the DMRS 320 to the UE, the network entity may select a CDM group for encoding the DMRS 320. A CDM group may include a group of resource elements (e.g., in an REG) for DMRS 320 transmissions for which time direction orthogonal code, frequency direction orthogonal code, or both may be applied.

In some cases, the network entity may select the CDM group based on identifying a phase change pattern for the CDM across the set of resource elements. For example, CDM groups may include groups of DMRSs 320 that are separated via CDM in the time domain or in the frequency domain, and where code associated with the CDM indicates a phase with which the network entity may transmit the DMRSs 320 (e.g., a positive (+) phase or a negative (−) phase). In addition, the CDM groups may be applied to the DMRSs 320 in the frequency domain regardless of a quantity of symbols 310 included in the CCE 305 or the time domain when two or more symbols 310 are included in the CCE 305.

In the example of FIG. 3, a CCE 305-a may include three symbols 310 in the time domain and two RBs 315 each including three DMRSs 320 and data 325 in the frequency domain. That is, the CCE 305-a may include six DRMSs 320 and eighteen data 325 per symbol 310, for a total of eighteen DMRSs 320 and fifty-four data 325 across the three symbols 310. In some examples, the network entity may apply two CDM groups to the CCE 305-a in the frequency domain (e.g., via FDM). A first CDM group may include a phase change pattern +/+, +/+, +/+ applied to each of the three symbols 310 and a second CDM group may include a phase change pattern +/−, +/+, +/− applied to each of the three symbols 310, where the first CDM group and the second CDM group may applied to alternating DMRSs 320 in frequency. In some other cases, the first CDM group and the second CDM group may be applied to alternating DMRSs 320 in time.

In some cases, a CCE 305-b may include three symbols 310 in the time domain and two RBs 315, each including three DMRSs 320 and data 325, in the frequency domain. That is, the CCE 305-a may include six DRMSs 320 and eighteen data 325 per symbol 310, for a total of eighteen DMRSs 320 and fifty-four data 325 across the three symbols 310. The network entity may apply two CDM groups to the CCE 305-b in the time domain (e.g., via TDM). In some cases, the CDM groups may be duplicated such that a phase change pattern is repeated across the CCE 305-b in frequency or time, or both. For example, a first CDM group may include a phase change pattern +/+, +/−, +/+ applied to each of the three symbols 310, and a second CDM group may include a phase change pattern +/−, +/+, +/− applied to each of the three symbols 310, where first CDM group and the second CDM group may be duplicated on alternating DMRSs 320 in time.

In some examples, a CCE 305-c may include two symbols 310 in the time domain and three RBs 315, each including three DMRSs 320 and data 325, in the frequency domain. That is, the CCE 305-a may include nine DRMSs 320 and twenty-seven data 325 per symbol 310, for a total of eighteen DMRSs 320 and fifty-four data 325 across the two symbols 310. In some examples, the network entity may apply two CDM groups to the CCE 305-c in the frequency domain (e.g., via FDM). A first CDM group may include a phase change pattern of +/+, +/+ applied to each of the two symbols 310 and a second CDM group may include a phase change pattern of +/−, +/− applied to each of the two symbols 310, where the first CDM group and the second CDM group may be applied to alternating DMRSs 320 in the frequency domain. As such, the phase change pattern applied to the CCE 305-c may be relatively regular. In some other examples, a CCE 305-d may include two symbols 310 in the time domain and three RBs 315, each including three DMRSs 320 and data 325, in the frequency domain. That is, the CCE 305-a may include nine DRMSs 320 and twenty-seven data 325 per symbol 310, for a total of eighteen DMRSs 320 and fifty-four data 325 across the two symbols 310. The network entity may apply two CDM groups to the CCE 305-d in the time domain (e.g., via TDM). A first CDM group may include a phase change pattern of +/+, +/− applied to each of the two symbols 310 and a second CDM group may include a phase change pattern of +/+, +/− applied to each of the two symbols 310, where the first CDM group and the second CDM group may be duplicated to each DMRS 320 in the time domain.

In some cases, a CCE 305-e may include one symbol 310 in the time domain and six RBs 315, each including three DMRSs 320 and data 325, in the frequency domain. That is, the CCE 305-e may include eighteen total DMRSs 320 and fifty-four data 325 in the symbol 310. Because the CCE 305-e includes one symbol 310, the CCE 305-e may fail to apply CDM groups in the time domain. As such, the CCE 305-e may include a first CDM group with a phase change pattern of +/+ applied to the symbol 310 and a second CDM group may include a phase change pattern of +/− applied to the symbol 310, where the first CDM group and the second CDM group may be applied to alternating DMRSs 320 in the frequency domain. In some examples, because there are eighteen DMRSs 320 included in one symbol 310 in the CCE 305-e, up to four CDM groups may be applied to the DMRSs 320 in the CCE 305-e. For example, the four CDM groups may include phase change patterns of +/++/+, +/+−/−, +/−+/−, +/−−/+, or any combination thereof, where each CDM group may be applied to each fourth DMRS 320 in the frequency domain.

A UE may recognize a phase change pattern applied to a CCE 305 of a PDCCH if the UE is aware of the different phase change patterns that may be applied (e.g., a combination of positive and negative phase changes applied to different DMRSs 320 across a CCE 305 in the frequency domain, the time domain, or both). That is, the UE may still attempt a channel estimation with multiple phase change patterns until the channel estimate is successful to identify the phase change pattern without knowing which phase change pattern (e.g., which CDM groups) the network entity applied to the DMRSs 320.

For each CCE 305, the quantity of DMRSs 320 in the CCEs 305 may remain the same (e.g., eighteen DMRSs 320), which may enable the same quantity of resource elements to be allocated for the data within a PDCCH at all times. As such, polar encoding for the PDCCH may remain the same for each CCE 305 based on a constant number of bits being carried in each CCE 305 (e.g., calculated as E=6*9*2=108 bits, where 6 represents the quantity of PRBs in a CCE 305, 9 represents the quantity of subcarriers in the CCE 305, and 2 represents a QPSK modulation format).

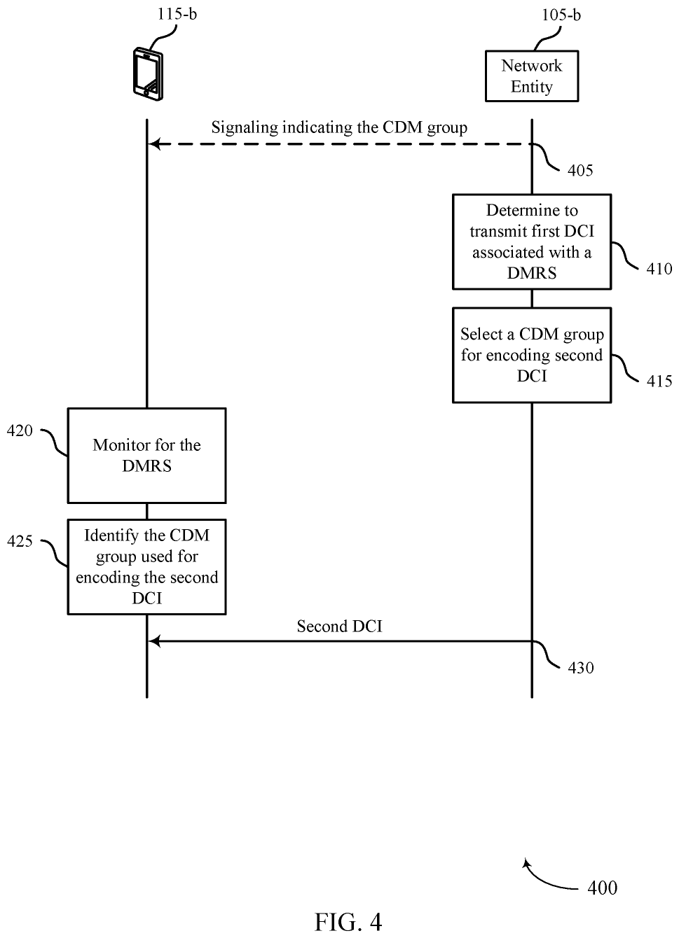

FIG. 4 illustrates an example of a process flow 400 that supports spatial multiplexing of control information for massive MIMO communications in accordance with one or more aspects of the present disclosure. The process flow 400 may implement aspects of wireless communications systems 100 and 200, or may be implemented by aspects of the wireless communications system 100 and 200. For example, the process flow 400 may illustrate operations between a UE 115-b and a network entity 105-b, which may be examples of corresponding devices described herein. In the following description of the process flow 400, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 400, and other operations may be added to the process flow 400.

At 405, the UE 115-b may receive, from the network entity 105-b, signaling indicating a CDM group for encoding second DCI. In some examples, the signaling may include MAC signaling, an additional DCI, or RRC signaling. In addition, the CDM group indicated in the signaling may become effective after a processing delay between receipt of the signaling and a first time interval based on whether the signaling includes the MAC signaling, the additional DCI, or the RRC signaling. For example, the CDM group may be applied to second DCI transmissions, where the UE 115-b may be aware of the known (e.g., indicated) CDM group.

At 410, the network entity 105-b may determine to transmit, to the UE 115-b and during a first time interval, the first DCI associated with a DMRS allocated to multiple resource elements of a control channel (e.g., a PDCCH). In some examples, the DMRS may enable the UE 115-b to decode data transmitted via the control channel (e.g., second DCI transmissions).

At 415, the network entity 105-b may select a CDM group for encoding the second DCI based on determining to transmit the first DCI. In some examples, the network entity 105-b may identify a phase change pattern for the CDM across the multiple resource elements that is associated with the CDM group, and select the CDM group based on identifying the phase change pattern. The phase change pattern may indicate whether the second DCI is to be transmitted with a positive phase shift or a negative phase shift (e.g., such that the CDM group may be multiplied by a negative or positive multiple).

At 420, the UE 115-b may monitor, during the first time interval, for the DMRS allocated to the multiple resource elements of the control channel. In some examples, the UE 115-b may decode the control channel based on the monitoring and using the DMRS, for example, using a blind decoding process.

At 425, the UE 115-b may determine the CDM group for encoding the second DCI based on the monitored DMRS. In some examples, the UE 115-b may determine the CDM group based on receiving the signaling indicating the CDM group from the network entity 105-b. In some other examples, the UE 115-b may use blind decoding to determine the CDM group.

At 430, the UE 115-b may receive the second DCI via the control channel based on the CDM group determined in association with the second DCI. In some examples, the UE 115-b may receive the second DCI in a unicast transmission. For example, the network entity 105-b may determine that the second DCI is associated with a particular DCI format or a particular RNTI associated with the CDM group for encoding the second DCI, and the UE 115-b may receive the second DCI according to a DCI format or an RNTI associated with the UE 115-b. In some cases, the UE 115-b may receive the second DCI via a layer corresponding to the CDM group (e.g., an aggregation layer).

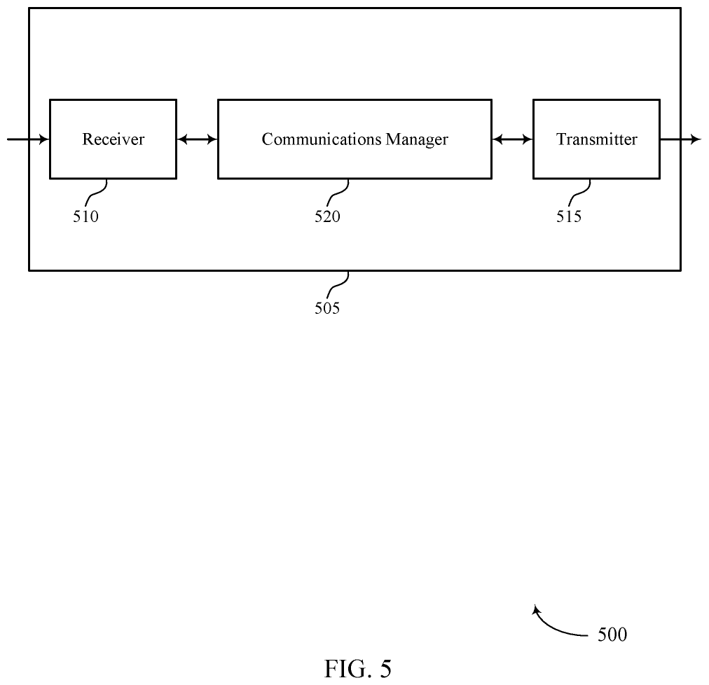

FIG. 5 shows a block diagram 500 of a device 505 that supports spatial multiplexing of control information for massive MIMO output in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to spatial multiplexing of control information for massive MIMO). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to spatial multiplexing of control information for massive MIMO). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of spatial multiplexing of control information for massive MIMO as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and a memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for monitoring, during a first time interval, for a DMRS allocated to a set of multiple resource elements of a control channel. The communications manager 520 may be configured as or otherwise support a means for determining a CDM group for encoding DCI based on the monitored DMRS. The communications manager 520 may be configured as or otherwise support a means for receiving the DCI via the control channel based on the CDM group determined in association with the DCI.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for spatial multiplexing of control information (e.g., DCI) for massive MIMO, which may reduce processing and increase utilization efficiency of communication resources.

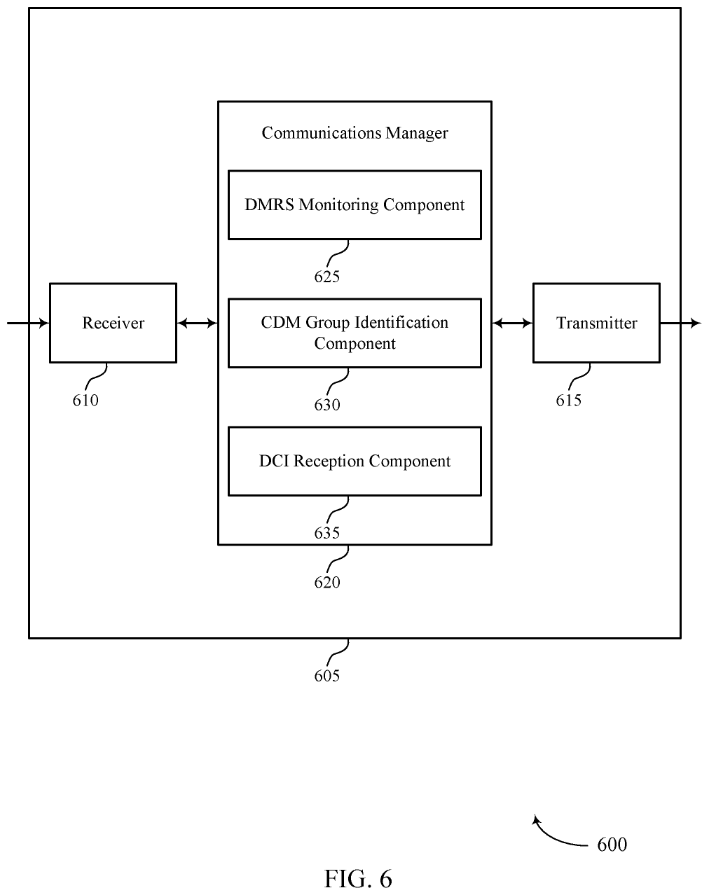

FIG. 6 shows a block diagram 600 of a device 605 that supports spatial multiplexing of control information for massive MIMO communications in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to spatial multiplexing of control information for massive MIMO). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to spatial multiplexing of control information for massive MIMO). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of spatial multiplexing of control information for massive MIMO as described herein. For example, the communications manager 620 may include a DMRS monitoring component 625, a CDM group identification component 630, a DCI reception component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The DMRS monitoring component 625 may be configured as or otherwise support a means for monitoring, during a first time interval, for a DMRS allocated to a set of multiple resource elements of a control channel. The CDM group identification component 630 may be configured as or otherwise support a means for determining a CDM group for encoding the DCI based on the monitored DMRS. The DCI reception component 635 may be configured as or otherwise support a means for receiving the DCI via the control channel based on the CDM group determined in association with the DCI.

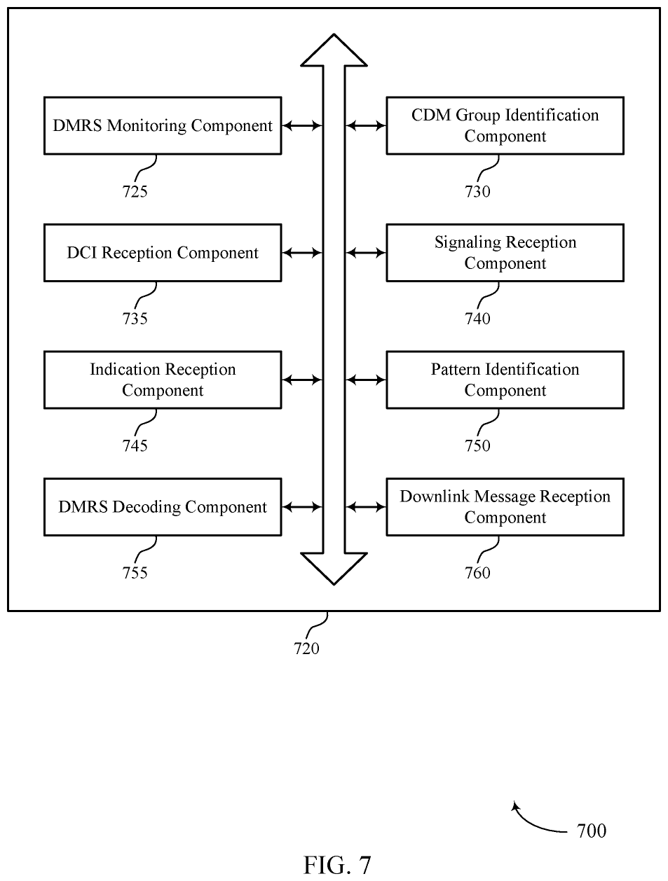

FIG. 7 shows a block diagram 700 of a communications manager 720 that supports spatial multiplexing of control information for massive MIMO communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of spatial multiplexing of control information for massive MIMO as described herein. For example, the communications manager 720 may include a DMRS monitoring component 725, a CDM group identification component 730, a DCI reception component 735, a signaling reception component 740, an indication reception component 745, a pattern identification component 750, a DMRS decoding component 755, a downlink message reception component 760, or any combination thereof. Each of these components may communicate, directly or indirectly, with one another (e.g., via one or more buses).

The communications manager 720 may support wireless communication at a UE in accordance with examples as disclosed herein. The DMRS monitoring component 725 may be configured as or otherwise support a means for monitoring, during a first time interval, for a DMRS allocated to a set of multiple resource elements of a control channel. The CDM group identification component 730 may be configured as or otherwise support a means for determining a CDM group for encoding the DCI based on the monitored DMRS. The DCI reception component 735 may be configured as or otherwise support a means for receiving the DCI via the control channel based on the CDM group determined in association with the DCI.

In some examples, to support determining the CDM group, the signaling reception component 740 may be configured as or otherwise support a means for receiving signaling indicating the CDM group for encoding the DCI.

In some examples, the signaling is one or more of MAC signaling, an additional DCI, or RRC signaling. In some examples, a processing delay between receipt of the signaling and the first time interval is based on whether the signaling is received via MAC signaling, the additional DCI, or RRC signaling.

In some examples, to support determining the CDM group, the indication reception component 745 may be configured as or otherwise support a means for receiving an indication of the CDM group in RRC parameters associated with a CORESET in which the DCI is received.

In some examples, to support determining the CDM group, the pattern identification component 750 may be configured as or otherwise support a means for identifying a pattern for the CDM across the set of multiple resource elements as part of a blind decoding process, the pattern corresponding to a phase change pattern across the set of multiple resource elements that is associated with the CDM group. In some examples, to support determining the CDM group, the CDM group identification component 730 may be configured as or otherwise support a means for determining the CDM group based on identifying the pattern that is associated with the CDM group.

In some examples, the DMRS decoding component 755 may be configured as or otherwise support a means for decoding the control channel based on the monitoring, where determining the CDM group is based on the decoding.

In some examples, the downlink message reception component 760 may be configured as or otherwise support a means for receiving a downlink message via a shared channel, the downlink message scheduled by the DCI, where the DCI and the downlink message are received on a same beam.

In some examples, to support monitoring for the DMRS, the DMRS monitoring component 725 may be configured as or otherwise support a means for monitoring, during one or more additional time intervals, for the DMRS, where the DCI received via the control channel is distinguishable from others of a set of multiple DCI received during the first time interval or the one or more additional time intervals based on the CDM. In some examples, to support receiving the DCI, the DCI reception component 735 may be configured as or otherwise support a means for receiving the DCI via a unicast transmission.

In some examples, to support receiving the DCI, the DCI reception component 735 may be configured as or otherwise support a means for determining that the DCI is associated with a DCI format or a random network identifier, where at least one of the DCI format or the random network identifier is of a type with which CDM is used.

In some examples, to support receiving the DCI, the DCI reception component 735 may be configured as or otherwise support a means for receiving the DCI only via a layer corresponding to the CDM group.

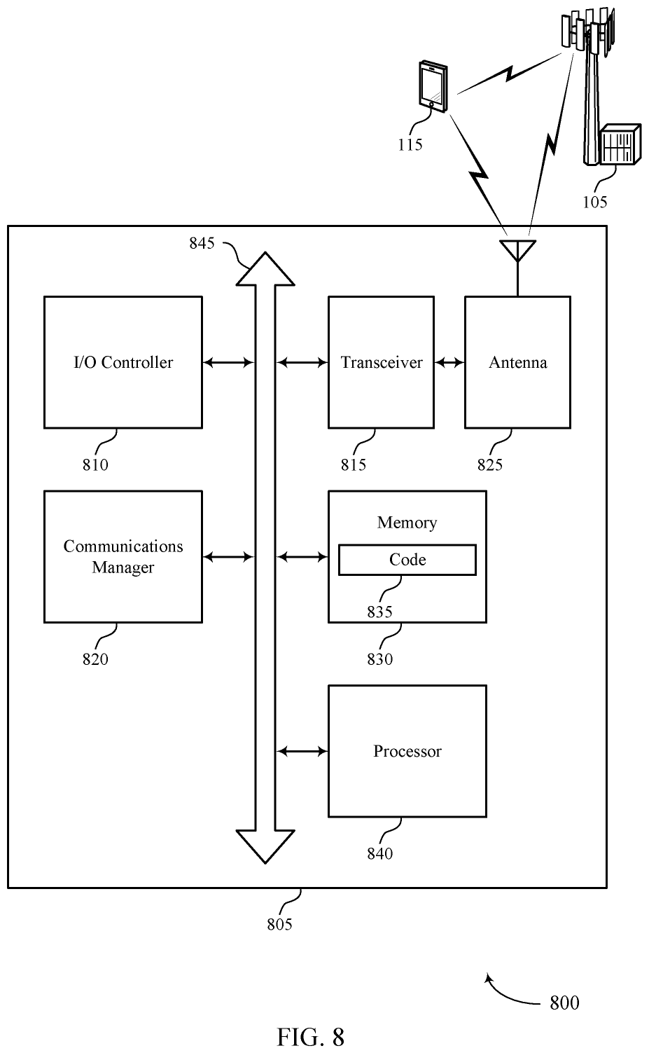

FIG. 8 shows a diagram of a system 800 including a device 805 that supports spatial multiplexing of control information for massive MIMO communications in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting spatial multiplexing of control information for massive MIMO). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for monitoring, during a first time interval, for a DMRS allocated to a set of multiple resource elements of a control channel. The communications manager 820 may be configured as or otherwise support a means for determining a CDM group for encoding DCI based on the monitored DMRS. The communications manager 820 may be configured as or otherwise support a means for receiving the DCI via the control channel based on the CDM group determined in association with the DCI.

By including or configuring the communications manager 820 in accordance with examples as described herein, the device 805 may support techniques for spatial multiplexing of control information (e.g., DCI) for massive MIMO, which may reduce processing and increase utilization efficiency of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of spatial multiplexing of control information for massive MIMO as described herein, or the processor 840 and the memory 830 may be otherwise configured to perform or support such operations.

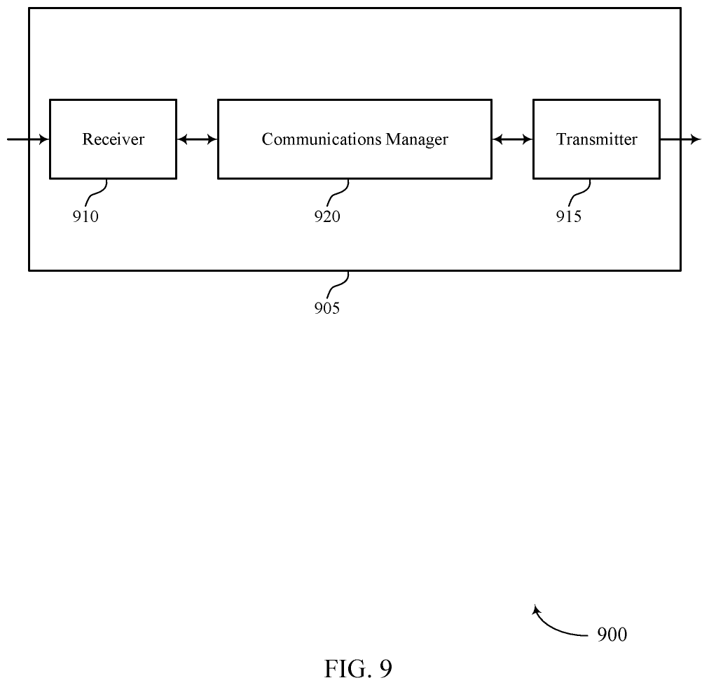

FIG. 9 shows a block diagram 900 of a device 905 that supports spatial multiplexing of control information for massive MIMO communications in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of spatial multiplexing of control information for massive MIMO as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and a memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for determining to transmit, during a first time interval, first DCI associated with a DMRS allocated to a set of multiple resource elements of a control channel. The communications manager 920 may be configured as or otherwise support a means for selecting a CDM group for encoding second DCI based on determining to transmit the first DCI. The communications manager 920 may be configured as or otherwise support a means for transmitting the second DCI via the control channel based on the CDM group selected for encoding the second DCI.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for spatial multiplexing of control information (e.g., DCI) for massive MIMO, which may reduce processing and increase utilization efficiency of communication resources.

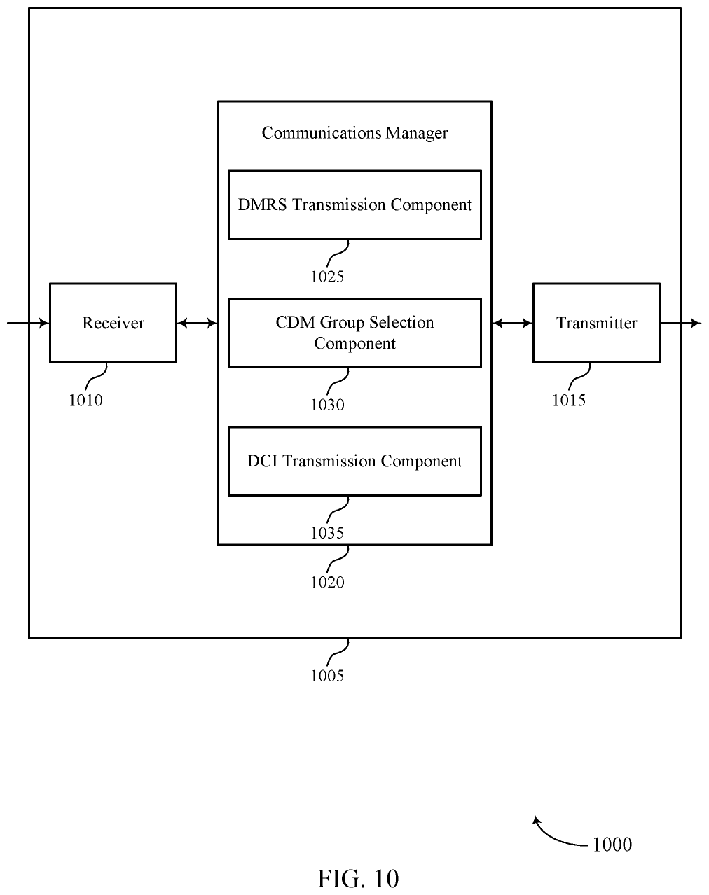

FIG. 10 shows a block diagram 1000 of a device 1005 that supports spatial multiplexing of control information for massive MIMO communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of spatial multiplexing of control information for massive MIMO as described herein. For example, the communications manager 1020 may include a DMRS transmission component 1025, a CDM group selection component 1030, a DCI transmission component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The DMRS transmission component 1025 may be configured as or otherwise support a means for determining to transmit, during a first time interval, first DCI associated with a DMRS allocated to a set of multiple resource elements of a control channel. The CDM group selection component 1030 may be configured as or otherwise support a means for selecting a CDM group for encoding second DCI based on determining to transmit the first DCI. The DCI transmission component 1035 may be configured as or otherwise support a means for transmitting the second DCI via the control channel based on the CDM group selected for encoding the second DCI.

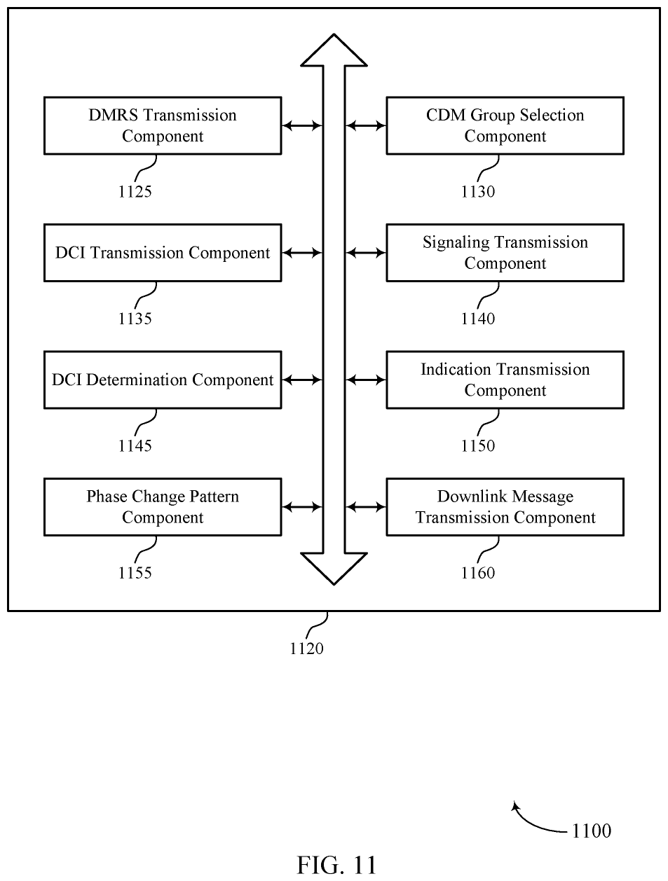

FIG. 11 shows a block diagram 1100 of a communications manager 1120 that supports spatial multiplexing of control information for massive MIMO communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of spatial multiplexing of control information for massive MIMO as described herein. For example, the communications manager 1120 may include a DMRS transmission component 1125, a CDM group selection component 1130, a DCI transmission component 1135, a signaling transmission component 1140, a DCI determination component 1145, an indication transmission component 1150, a phase change pattern component 1155, a downlink message transmission component 1160, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The DMRS transmission component 1125 may be configured as or otherwise support a means for determining to transmit, during a first time interval, first DCI associated with a DMRS allocated to a set of multiple resource elements of a control channel. The CDM group selection component 1130 may be configured as or otherwise support a means for selecting a CDM group for encoding the second DCI based on determining to transmit the first DCI. The DCI transmission component 1135 may be configured as or otherwise support a means for transmitting the second DCI via the control channel based on the CDM group selected for encoding the second DCI.

In some examples, the signaling transmission component 1140 may be configured as or otherwise support a means for transmitting signaling indicating the CDM group for encoding the second DCI.

In some examples, the signaling is one or more of MAC signaling, an additional DCI, or RRC signaling. In some examples, a processing delay between receipt of the signaling and the first time interval is based on whether the signaling is received via MAC signaling, the additional DCI, or RRC signaling.

In some examples, to support transmitting the second DCI, the DCI transmission component 1135 may be configured as or otherwise support a means for transmitting the second DCI via a unicast transmission. In some examples, to support transmitting the second DCI, the DCI determination component 1145 may be configured as or otherwise support a means for determining that the second DCI is associated with a DCI format or a random network identifier, where at least one of the DCI format or the random network identifier is of a type with which CDM is used.

In some examples, to support transmitting the second DCI, the DCI transmission component 1135 may be configured as or otherwise support a means for transmitting the second DCI only via a layer corresponding to the CDM group.

In some examples, to support selecting the CDM group, the indication transmission component 1150 may be configured as or otherwise support a means for transmitting an indication of the CDM group in RRC parameters associated with a CORESET in which the second DCI is transmitted.

In some examples, to support selecting the CDM group, the phase change pattern component 1155 may be configured as or otherwise support a means for identifying a pattern for the CDM across the set of multiple resource elements, the pattern corresponding to a phase change pattern across the set of multiple resource elements that is associated with the CDM group. In some examples, to support selecting the CDM group, the CDM group selection component 1130 may be configured as or otherwise support a means for selecting the CDM group based on identifying the pattern that is associated with the CDM group.

In some examples, the downlink message transmission component 1160 may be configured as or otherwise support a means for transmitting a downlink message via a shared channel, the downlink message scheduled by the second DCI, where the second DCI and the downlink message are transmitted on a same beam.

In some examples, to support determining to transmit the first DCI associated with the DMRS, the DMRS transmission component 1125 may be configured as or otherwise support a means for determining to transmit, during one or more additional time intervals, the first DCI, where the second DCI transmitted via the control channel is distinguishable from others of a set of multiple second DCI transmitted during the first time interval or the one or more additional time intervals based on the CDM.

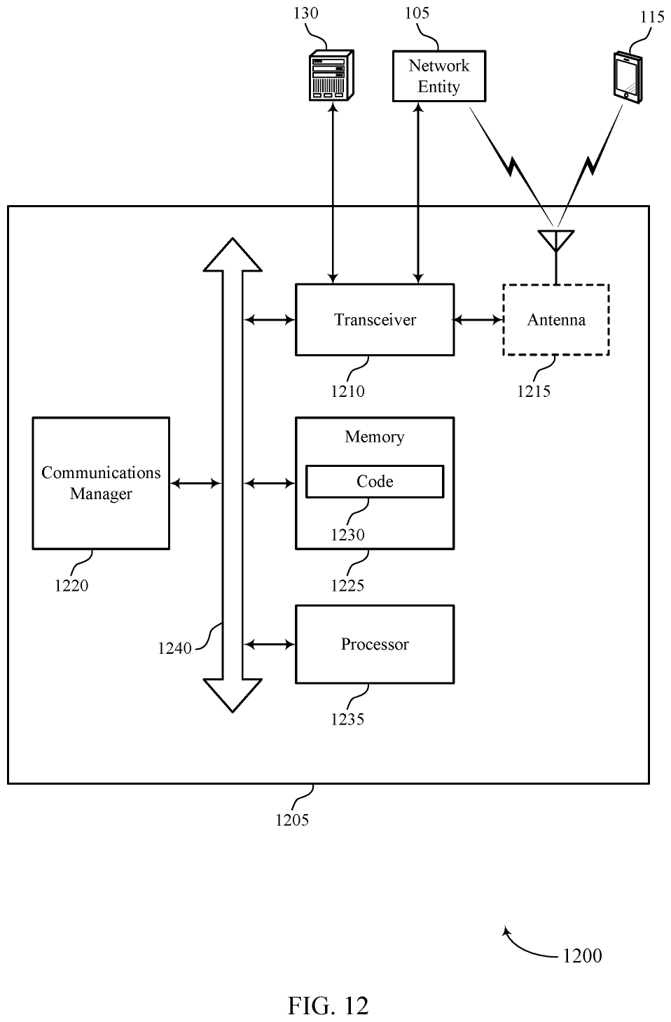

FIG. 12 shows a diagram of a system 1200 including a device 1205 that supports spatial multiplexing of control information for massive MIMO communications in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting spatial multiplexing of control information for massive MIMO). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for determining to transmit, during a first time interval, first DCI associated with a DMRS allocated to a set of multiple resource elements of a control channel. The communications manager 1220 may be configured as or otherwise support a means for selecting a CDM group for encoding second DCI based on determining to transmit the first DCI. The communications manager 1220 may be configured as or otherwise support a means for transmitting the second DCI via the control channel based on the CDM group selected for encoding the second DCI.

By including or configuring the communications manager 1220 in accordance with examples as described herein, the device 1205 may support techniques for spatial multiplexing of control information (e.g., DCI) for massive MIMO, which may reduce processing and increase utilization efficiency of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of spatial multiplexing of control information for massive MIMO as described herein, or the processor 1235 and the memory 1225 may be otherwise configured to perform or support such operations.

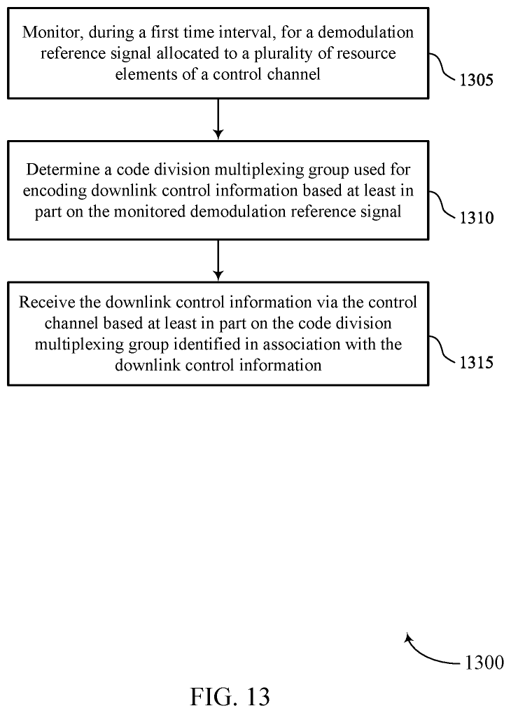

FIG. 13 shows a flowchart illustrating a method 1300 that supports spatial multiplexing of control information for massive MIMO communications in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include monitoring, during a first time interval, for a DMRS allocated to a plurality of multiple resource elements of a control channel. The operations of 1305 may be performed in accordance with examples as disclosed herein. In some examples, aspects of the operations of 1305 may be performed by a DMRS monitoring component 725 as described with reference to FIG. 7.

At 1310, the method may include determining a CDM group for encoding DCI based at least in part on the monitoring. The operations of 1310 may be performed in accordance with examples as disclosed herein. In some examples, aspects of the operations of 1310 may be performed by a CDM group identification component 730 as described with reference to FIG. 7.

At 1315, the method may include receiving the DCI via the control channel based at least in part on the CDM group determined in association with the DCI. The operations of 1315 may be performed in accordance with examples as disclosed herein. In some examples, aspects of the operations of 1315 may be performed by a DCI reception component 735 as described with reference to FIG. 7.

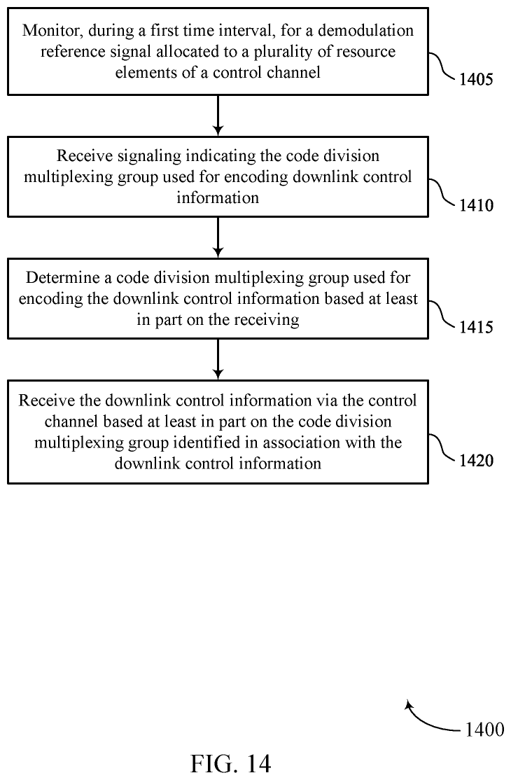

FIG. 14 shows a flowchart illustrating a method 1400 that supports spatial multiplexing of control information for massive MIMO communications in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include monitoring, during a first time interval, for a DMRS allocated to a plurality of multiple resource elements of a control channel. The operations of 1405 may be performed in accordance with examples as disclosed herein. In some examples, aspects of the operations of 1405 may be performed by a DMRS monitoring component 725 as described with reference to FIG. 7.

At 1410, the method may include receiving signaling indicating the CDM group for encoding DCI. The operations of 1410 may be performed in accordance with examples as disclosed herein. In some examples, aspects of the operations of 1410 may be performed by a signaling reception component 740 as described with reference to FIG. 7.

At 1415, the method may include determining a CDM group for encoding the DCI based at least in part on the receiving. The operations of 1415 may be performed in accordance with examples as disclosed herein. In some examples, aspects of the operations of 1415 may be performed by a CDM group identification component 730 as described with reference to FIG. 7.

At 1420, the method may include receiving the DCI via the control channel based at least in part on the CDM group determined in association with the DCI. The operations of 1420 may be performed in accordance with examples as disclosed herein. In some examples, aspects of the operations of 1420 may be performed by a DCI reception component 735 as described with reference to FIG. 7.

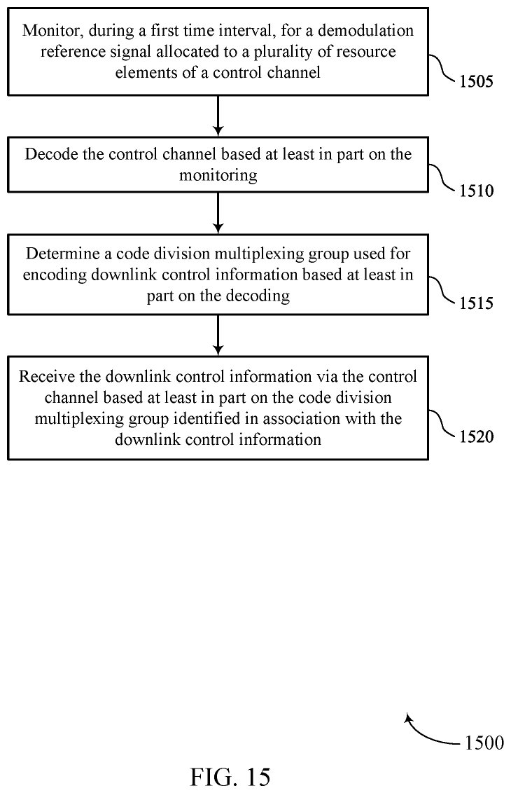

FIG. 15 shows a flowchart illustrating a method 1500 that supports spatial multiplexing of control information for massive MIMO communications in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include monitoring, during a first time interval, for a DMRS allocated to a plurality of multiple resource elements of a control channel. The operations of 1505 may be performed in accordance with examples as disclosed herein. In some examples, aspects of the operations of 1505 may be performed by a DMRS monitoring component 725 as described with reference to FIG. 7.

At 1510, the method may include decoding the control channel based at least in part on the monitoring. The operations of 1510 may be performed in accordance with examples as disclosed herein. In some examples, aspects of the operations of 1510 may be performed by a DMRS decoding component 755 as described with reference to FIG. 7.

At 1515, the method may include determining a CDM group for encoding the DCI based at least in part on the decoding. The operations of 1515 may be performed in accordance with examples as disclosed herein. In some examples, aspects of the operations of 1515 may be performed by a CDM group identification component 730 as described with reference to FIG. 7.

At 1520, the method may include receiving the DCI via the control channel based at least in part on the CDM group determined in association with the DCI. The operations of 1520 may be performed in accordance with examples as disclosed herein. In some examples, aspects of the operations of 1520 may be performed by a DCI reception component 735 as described with reference to FIG. 7.

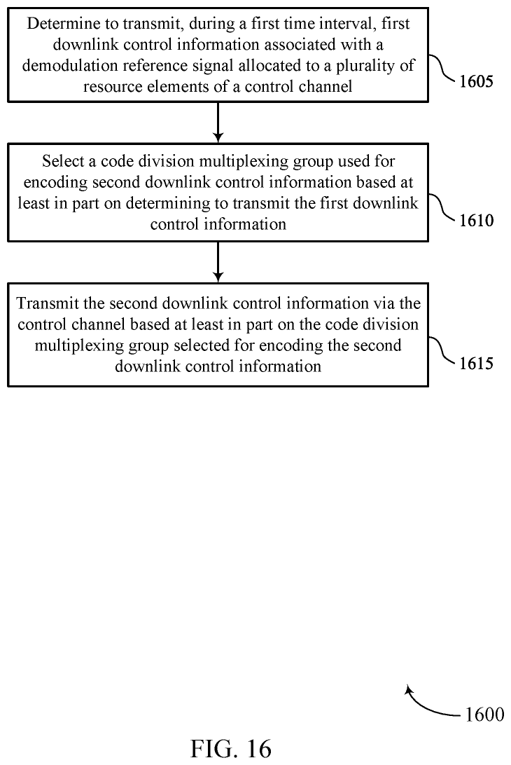

FIG. 16 shows a flowchart illustrating a method 1600 that supports spatial multiplexing of control information for massive MIMO communications in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include determining to transmit, during a first time interval, first DCI associated with a DMRS allocated to a plurality of multiple resource elements of a control channel. The operations of 1605 may be performed in accordance with examples as disclosed herein. In some examples, aspects of the operations of 1605 may be performed by a DMRS transmission component 1125 as described with reference to FIG. 11.

At 1610, the method may include selecting a CDM group for encoding second DCI based at least in part on determining to transmit the first DCI. The operations of 1610 may be performed in accordance with examples as disclosed herein. In some examples, aspects of the operations of 1610 may be performed by a CDM group selection component 1130 as described with reference to FIG. 11.

At 1615, the method may include transmitting the second DCI via the control channel based at least in part on the CDM group selected for encoding the second DCI. The operations of 1615 may be performed in accordance with examples as disclosed herein. In some examples, aspects of the operations of 1615 may be performed by a DCI transmission component 1135 as described with reference to FIG. 11.

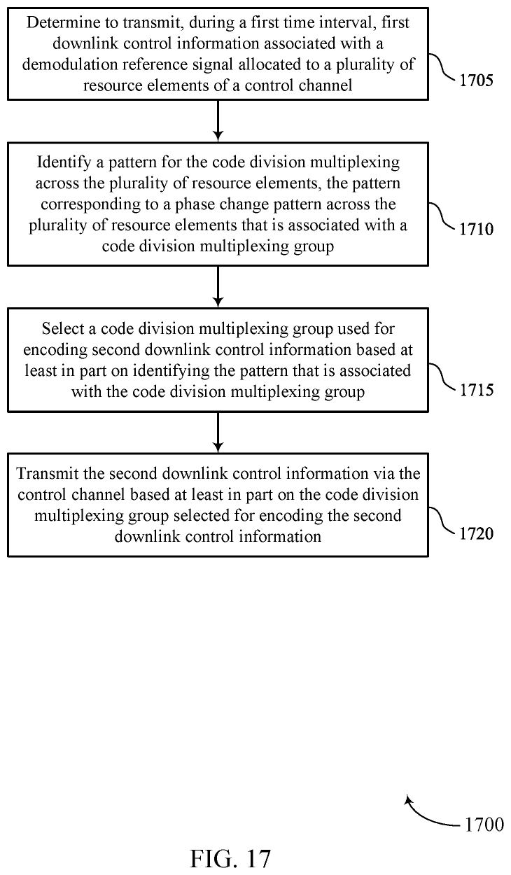

FIG. 17 shows a flowchart illustrating a method 1700 that supports spatial multiplexing of control information for massive MIMO communications in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include determining to transmit, during a first time interval, first DCI associated with a DMRS allocated to a plurality of multiple resource elements of a control channel. The operations of 1705 may be performed in accordance with examples as disclosed herein. In some examples, aspects of the operations of 1705 may be performed by a DMRS transmission component 1125 as described with reference to FIG. 11.

At 1710, the method may include identifying a pattern for the CDM across the plurality of multiple resource elements, the pattern corresponding to a phase change pattern across the plurality of multiple resource elements that is associated with a CDM group. The operations of 1710 may be performed in accordance with examples as disclosed herein. In some examples, aspects of the operations of 1710 may be performed by a CDM group selection component 1130 as described with reference to FIG. 11.

At 1715, the method may include selecting a CDM group for encoding the second DCI based at least in part on identifying the pattern that is associated with the CDM group. The operations of 1715 may be performed in accordance with examples as disclosed herein. In some examples, aspects of the operations of 1715 may be performed by a phase change pattern component 1155 as described with reference to FIG. 11.

At 1720, the method may include transmitting the second DCI via the control channel based at least in part on the CDM group selected for encoding the second DCI. The operations of 1720 may be performed in accordance with examples as disclosed herein. In some examples, aspects of the operations of 1720 may be performed by a DCI transmission component 1135 as described with reference to FIG. 11.

The following provides an overview of aspects of the present disclosure:

Aspect 1: A method for wireless communication at a UE, comprising: monitoring, during a first time interval, for a demodulation reference signal allocated to a plurality of resource elements of a control channel: determining a CDM group for encoding DCI based at least in part on the monitored demodulation reference signal: and receiving the DCI via the control channel based at least in part on the CDM group determined in association with the DCI.

Aspect 2: The method of aspect 1, wherein determining the CDM group further comprises: receiving signaling indicating the CDM group for encoding the DCI.

Aspect 3: The method of aspect 2, wherein the signaling is one or more of MAC signaling, an additional DCI, or RRC signaling.

Aspect 4: The method of aspect 3, wherein a processing delay between receipt of the signaling and the first time interval is based at least in part on whether the signaling is received via MAC signaling, the additional DCI, or RRC signaling.

Aspect 5: The method of any of aspects 1 through 4, wherein determining the CDM group further comprises: receiving an indication of the CDM group in RRC parameters associated with a control resource set in which the DCI is received.

Aspect 6: The method of any of aspects 1 through 5, wherein determining the CDM group comprises: identifying a pattern for the CDM across the plurality of resource elements as part of a blind decoding process, the pattern corresponding to a phase change pattern across the plurality of resource elements that is associated with the CDM group; and determining the CDM group based at least in part on identifying the pattern that is associated with the CDM group.

Aspect 7: The method of any of aspects 1 through 6, further comprising: decoding the control channel based at least in part on the monitored demodulation reference signal, wherein determining the CDM group is based at least in part on the decoding.

Aspect 8: The method of any of aspects 1 through 7, further comprising: receiving a downlink message via a shared channel, the downlink message scheduled by the DCI, wherein the DCI and the downlink message are received on a same beam.

Aspect 9: The method of any of aspects 1 through 8, wherein monitoring for the demodulation reference signal further comprises: monitoring, during one or more additional time intervals, for the demodulation reference signal, wherein the DCI received via the control channel is distinguishable from others of a plurality of DCI received during the first time interval or the one or more additional time intervals based at least in part on the CDM.

Aspect 10: The method of any of aspects 1 through 9, wherein receiving the DCI comprises: receiving the DCI via a unicast transmission.

Aspect 11: The method of any of aspects 1 through 10, wherein receiving the DCI comprises: determining that the DCI is associated with a DCI format or a random network identifier, wherein at least one of the DCI format or the random network identifier is of a type with which CDM is used.

Aspect 12: The method of any of aspects 1 through 11, wherein receiving the DCI comprises: receiving the DCI only via a layer corresponding to the CDM group.

Aspect 13: A method for wireless communication at a network entity, comprising: determining to transmit, during a first time interval, first DCI associated with a demodulation reference signal allocated to a plurality of resource elements of a control channel: selecting a CDM group for encoding second DCI based at least in part on determining to transmit the first DCI; and transmitting the second DCI via the control channel based at least in part on the CDM group selected for encoding the second DCI.

Aspect 14: The method of aspect 13, further comprising: transmitting signaling indicating the CDM group for encoding the second DCI.

Aspect 15: The method of aspect 14, wherein the signaling is one or more of MAC signaling, an additional DCI, or RRC signaling.

Aspect 16: The method of aspect 15, wherein a processing delay between receipt of the signaling and the first time interval is based at least in part on whether the signaling is received via MAC signaling, the additional DCI, or RRC signaling.

Aspect 17: The method of any of aspects 13 through 16, wherein transmitting the second DCI comprises: transmitting the second DCI via a unicast transmission.

Aspect 18: The method of any of aspects 13 through 17, wherein transmitting the second DCI comprises: determining that the second DCI is associated with a DCI format or a random network identifier, wherein at least one of the DCI format or the random network identifier is of a type with which CDM is used.

Aspect 19: The method of any of aspects 13 through 18, wherein transmitting the second DCI comprises: transmitting the second DCI only via a layer corresponding to the CDM group.

Aspect 20: The method of any of aspects 13 through 19, wherein selecting the CDM group further comprises: transmitting an indication of the CDM group in RRC parameters associated with a control resource set in which the second DCI is transmitted.

Aspect 21: The method of any of aspects 13 through 20, wherein selecting the CDM group comprises: identifying a pattern for the CDM across the plurality of resource elements, the pattern corresponding to a phase change pattern across the plurality of resource elements that is associated with the CDM group; and selecting the CDM group based at least in part on identifying the pattern that is associated with the CDM group.

Aspect 22: The method of any of aspects 13 through 21, further comprising: transmitting a downlink message via a shared channel, the downlink message scheduled by the second DCI, wherein the second DCI and the downlink message are transmitted on a same beam.

Aspect 23: The method of any of aspects 13 through 22, wherein determining to transmit the first DCI further comprises: determining to transmit, during one or more additional time intervals, the first DCI, wherein the second DCI transmitted via the control channel is distinguishable from others of a plurality of second DCI transmitted during the first time interval or the one or more additional time intervals based at least in part on the CDM.

Aspect 24: An apparatus for wireless communication at a UE, comprising a processor; and a memory coupled with the processor, wherein the memory comprises instructions executable by the processor to cause the apparatus to perform a method of any of aspects 1 through 12.

Aspect 25: An apparatus for wireless communication at a UE, comprising at least one means for performing a method of any of aspects 1 through 12.

Aspect 26: A non-transitory computer-readable medium storing code for wireless communication at a UE, the code comprising instructions executable by a processor to perform a method of any of aspects 1 through 12.

Aspect 27: An apparatus for wireless communication at a network entity, comprising a processor; and a memory coupled with the processor, wherein the memory comprises instructions executable by the processor to cause the apparatus to perform a method of any of aspects 13 through 23.

Aspect 28: An apparatus for wireless communication at a network entity, comprising at least one means for performing a method of any of aspects 13 through 23.

Aspect 29: A non-transitory computer-readable medium storing code for wireless communication at a network entity, the code comprising instructions executable by a processor to perform a method of any of aspects 13 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
monitoring, during a first time interval, for a demodulation reference signal allocated to a plurality of resource elements of a control channel;
determining a code division multiplexing group for encoding downlink control information based at least in part on the monitored demodulation reference signal; and
receiving the downlink control information via the control channel based at least in part on the code division multiplexing group determined in association with the downlink control information.

2. The method of claim 1, wherein determining the code division multiplexing group further comprises:
receiving signaling indicating the code division multiplexing group for encoding the downlink control information.

3. The method of claim 2, wherein the signaling is one or more of medium access control signaling, an additional downlink control information, or radio resource control signaling.

4. The method of claim 3, wherein a processing delay between receipt of the signaling and the first time interval is based at least in part on whether the signaling is received via medium access control signaling, the additional downlink control information, or radio resource control signaling.

5. The method of claim 1, wherein determining the code division multiplexing group further comprises:
receiving an indication of the code division multiplexing group in radio resource control parameters associated with a control resource set in which the downlink control information is received.

6. The method of claim 1, wherein determining the code division multiplexing group comprises:
identifying a pattern for the code division multiplexing across the plurality of resource elements as part of a blind decoding process, the pattern corresponding to a phase change pattern across the plurality of resource elements that is associated with the code division multiplexing group; and
determining the code division multiplexing group based at least in part on identifying the pattern that is associated with the code division multiplexing group.

7. The method of claim 1, further comprising:
decoding the control channel based at least in part on the monitored demodulation reference signal, wherein determining the code division multiplexing group is based at least in part on the decoding.

8. The method of claim 1, further comprising:
receiving a downlink message via a shared channel, the downlink message scheduled by the downlink control information, wherein the downlink control information and the downlink message are received on a same beam.

9. The method of claim 1, wherein monitoring for the demodulation reference signal further comprises:
monitoring, during one or more additional time intervals, for the demodulation reference signal, wherein the downlink control information received via the control channel is distinguishable from others of a plurality of downlink control information received during the first time interval or the one or more additional time intervals based at least in part on the code division multiplexing.

10. The method of claim 1, wherein receiving the downlink control information comprises:
receiving the downlink control information via a unicast transmission.

11. The method of claim 1, wherein receiving the downlink control information comprises:
determining that the downlink control information is associated with a downlink control information format or a random network identifier, wherein at least one of the downlink control information format or the random network identifier is of a type with which code division multiplexing is used.

12. The method of claim 1, wherein receiving the downlink control information comprises:
receiving the downlink control information only via a layer corresponding to the code division multiplexing group.

13. A method for wireless communication at a network entity, comprising:
determining to transmit, during a first time interval, first downlink control information associated with a demodulation reference signal allocated to a plurality of resource elements of a control channel;
selecting a code division multiplexing group for encoding second downlink control information based at least in part on determining to transmit the first downlink control information; and
transmitting the second downlink control information via the control channel based at least in part on the code division multiplexing group selected for encoding the second downlink control information.

14. The method of claim 13, further comprising:
transmitting signaling indicating the code division multiplexing group for encoding the second downlink control information.

15. The method of claim 14, wherein the signaling is one or more of medium access control signaling, an additional downlink control information, or radio resource control signaling.

16. The method of claim 15, wherein a processing delay between receipt of the signaling and the first time interval is based at least in part on whether the signaling is received via medium access control signaling, the additional downlink control information, or radio resource control signaling.

17. The method of claim 13, wherein transmitting the second downlink control information comprises:
transmitting the second downlink control information via a unicast transmission.

18. The method of claim 13, wherein transmitting the second downlink control information comprises:
determining that the second downlink control information is associated with a downlink control information format or a random network identifier, wherein at least one of the downlink control information format or the random network identifier is of a type with which code division multiplexing is used.

19. The method of claim 13, wherein transmitting the second downlink control information comprises:
transmitting the second downlink control information only via a layer corresponding to the code division multiplexing group.

20. The method of claim 13, wherein selecting the code division multiplexing group further comprises:
transmitting an indication of the code division multiplexing group in radio resource control parameters associated with a control resource set in which the second downlink control information is transmitted.

21. The method of claim 13, wherein selecting the code division multiplexing group comprises:
identifying a pattern for the code division multiplexing across the plurality of resource elements, the pattern corresponding to a phase change pattern across the plurality of resource elements that is associated with the code division multiplexing group; and
selecting the code division multiplexing group based at least in part on identifying the pattern that is associated with the code division multiplexing group.

22. The method of claim 13, further comprising:
transmitting a downlink message via a shared channel, the downlink message scheduled by the second downlink control information, wherein the second downlink control information and the downlink message are transmitted on a same beam.

23. The method of claim 13, wherein determining to transmit the first downlink control information further comprises:
determining to transmit, during one or more additional time intervals, the first downlink control information, wherein the second downlink control information transmitted via the control channel is distinguishable from others of a plurality of second downlink control information transmitted during the first time interval or the one or more additional time intervals based at least in part on the code division multiplexing.

24. An apparatus for wireless communication at a user equipment (UE), comprising:
a processor; and
a memory coupled with the processor, wherein the memory comprises instructions executable by the processor to cause the apparatus to:
monitor, during a first time interval, for a demodulation reference signal allocated to a plurality of resource elements of a control channel;
determine a code division multiplexing group for encoding downlink control information based at least in part on the monitored demodulation reference signal; and
receive the downlink control information via the control channel based at least in part on the code division multiplexing group determined in association with the downlink control information.

25. The apparatus of claim 24, wherein the instructions to determine the code division multiplexing group are further executable by the processor to cause the apparatus to:
receive signaling indicating the code division multiplexing group for encoding the downlink control information.

26. The apparatus of claim 25, wherein the signaling is one or more of medium access control signaling, an additional downlink control information, or radio resource control signaling.

27. The apparatus of claim 26, wherein a processing delay between receipt of the signaling and the first time interval is based at least in part on whether the signaling is received via medium access control signaling, the additional downlink control information, or radio resource control signaling.

28. An apparatus for wireless communication at a network entity, comprising:
a processor; and
a memory coupled with the processor, wherein the memory comprises instructions executable by the processor to cause the apparatus to:
determine to transmit, during a first time interval, first downlink control information associated with a demodulation reference signal allocated to a plurality of resource elements of a control channel;
select a code division multiplexing group for encoding second downlink control information based at least in part on determining to transmit the first downlink control information; and
transmit the second downlink control information via the control channel based at least in part on the code division multiplexing group selected for encoding the second downlink control information.

29. The apparatus of claim 28, wherein the instructions are further executable by the processor to cause the apparatus to:
transmit signaling indicating the code division multiplexing group for encoding the second downlink control information.

30. The apparatus of claim 29, wherein the signaling is one or more of medium access control signaling, an additional downlink control information, or radio resource control signaling.
